(19) United States
(12) Patent Application Publication
(10) Pub. No.: US 2007/0125365 A1
(43) Pub. Date: Jun. 7, 2007

(54) Steam generator

(76) Inventor: Thomas Frings, Schuld (DE)

Correspondence Address: Muirhead and Saturnelli, LLC, Suite 1001, 200 Friberg Parkway, Westborough, MA, 01581, US

(21) Appl. No.: 11/634,602

(22) Filed: Dec. 6, 2006

(30) Foreign Application Priority Data
Dec. 7, 2005 (DE) 10 2005 058 592.2

(51) Int. Cl. A21B 1/08; F24D 1/00

(52) U.S. Cl. 126/369; 126/20

(57) ABSTRACT

A steam generator comprises a vaporisation chamber in which are arranged at least one heating device, a heat storage body and a water feed device. The heat storage body includes a plurality of small elements that are movably connected together. The steam generator may be connected to a treatment chamber via at least one steam passage.

### TECHNICAL FIELD

This application is related to the field of steam generation and, more particularly, to a steam generator having a heat storage body.

### BACKGROUND OF THE INVENTION

Steam generators are used in the treatment of foodstuffs. For example, in baking technology baking chambers of ovens are steamed, that is to say a controlled flow of steam is fed to the baking chambers, to prevent the baked articles from drying out. Fermentation chambers for dough products which are processed in a later baking procedure to provide baked articles are also frequently supplied with steam in order to produce an atmosphere with a high level of air moisture content.

Usually rigid heat storage bodies are used in known steam generators. Frequently structural steel bars are laid on the heating device. The heating device can be formed for example by a heating coil which is heated by electric current, by a hot liquid such as heated thermal oil or a hot gas which is produced for example in the combustion of fuels. Such metal bars can comprise a disadvantageous heat distribution. Frequently they are heated so greatly that water which is fed into the vaporisation chamber vaporises instantaneously on the surface thereof and the resulting steam forms a separating layer between the metallic surface and the water drop. In addition it is relatively laborious to fill vaporisation chamber with the individual rigid heat storage bodies. Finally, complete filling is possible only insofar as the contour of the heat storage bodies can be introduced into the contour of the baking chamber.

In other configurations elongate metal profile members are arranged in the region of the heating device. Those profile members can have ribs in order to increase the size of their surface area which can be brought into contact with water. The length of the rigid profile members mostly corresponds to the width of the vaporisation chamber so that the above-described disadvantages also occur in this case.

Other steam generators are known from DE 31 03 529 A1 and EP 0 534 809 B1. Here the heat storage bodies comprise deformable material. In the case of DE 31 03 529 A1 the heat storage body is in the form of an elongate rod with steel bristles, in the form of steel sponge or in the form of a basket which is wrapped around with a wire mesh or a wire gauze. In the case of the heat storage bodies with a rigid rod or basket and flexible bristles or meshes, similar handling problems occur in the case of large steam generators, as with the above-described steam generators involving completely rigid heat storage bodies. If the heat storage bodies consist entirely of flexibly deformable material (for example steel sponge), handling is simplified. There is, however, the risk that the heat storage body is locally so heavily compressed and compacted that water is prevented from passing therethrough. That reduces the level of efficiency in terms of steam generation. In addition, flexibly deformable materials of metal cannot be deformed as often as may be desired so that heat storage bodies of that kind can be only rarely removed from the vaporisation chamber and re-introduced thereinto, with fresh deformation. If the heat storage bodies have to be removed in maintenance operations, then generally new heat storage bodies have to be introduced.

DE 1 146 602 and EP 0 597 748 describe heat generators whose heat storage bodies are formed by material, for example in ball form, which is poured into the vaporisation chamber. Handling those individual particles which form the heat storage body when introducing them into the vaporisation chamber and in particular when removing them and re-introducing them during maintenance operations is very tedious and complicated. There is the risk that some of the individual particles fall down and are lost or contaminate the location at which the handling procedure is effected.

Accordingly, it would be desirable to provide a steam generator having a heat storage body which is simple to handle and advantageous in regard to steam generation.

### SUMMARY OF THE INVENTION

According to an embodiment of the system described herein, a steam generator includes a vaporisation chamber in which are arranged at least one heating device, a heat storage body and a water feed device. The heat storage body comprises a plurality of small elements that are movably connected together.

In particular, the elements of the heat storage body may be metallic chain links. Alternatively, the elements of the heat storage body may be hingedly interconnected ball bodies or sheet metal portions coupled together by way of connecting rings, for example shredded sheet.

A heat storage body of that kind is easy to handle in the operation of filling the vaporisation chamber. The heat storage body in chain form is usually supplied wound on a drum and, for introducing it into the vaporisation chamber, can be simply unwound from the drum and passed into the chamber. The process involves uniform filling of the individual, movably interconnected elements of the heat storage body into the vaporisation chamber. A labyrinth is afforded within the vaporisation chamber between the rigid elements of the heat storage body (generally chain links), and the supplied water can move through the labyrinth under the effect of the force of gravity. In that case the small elements which are closest to the water feed device are greatly cooled so that they do not cause abrupt vaporisation of the water. The water which is introduced into the vaporisation chamber thus vaporises uniformly and permits even generation of steam.

Furthermore, by virtue of the hingedly interconnected elements of the heat storage body, the vaporisation chamber may be substantially completely filled with the material of the heat storage body. A larger amount of accommodated material undoubtedly results in a larger heat storage capacity. With an equal heating output, that results in an increase in the possible vaporisation amount with the same size for the vaporisation chamber, in comparison with the devices in the state of the art.

In practice the steam generator according to the system described herein may be used for the feed of steam to a treatment chamber for foodstuffs. In that case, the vaporisation chamber may be connected to the treatment chamber by way of steam passages. In a practical embodiment the treatment chamber may be a baking chamber of an oven.

The elements of the heat storage body may comprise metal, in particular iron or steel. Iron and steel have a high heat storage capacity, are robust, and are substantially immune to corrosion at the temperatures prevailing in the vaporisation chamber as well as being inexpensive to produce. In particular link chains of iron or steel are produced in large amounts and may be obtained inexpensively for use in a steam generator according to the system described herein. Depending on the respective purpose of use involved, however, it is also possible to use other heat-resistant materials such as, for example, aluminum.

The water feed device can in practice be formed by at least one injection pipe. In principle, however, any opening which is connected to a water feed line and which opens into the vaporisation chamber is suitable as the water feed device.

It is also possible to use any heating devices, for example heating coils, heating spirals or heating plates. Heating of the heating device can also take place in any fashion. In practice for example heating by electric current, by hot liquid such as heated thermal oil or by heated flue gases which are produced by combustion of a fuel have proven their worth.

According further to the system described herein, an apparatus includes a treatment chamber which has a steam generator as described herein which is connected to the treatment chamber via at least one steam passage. In that case, the treatment chamber may serve in particular for the treatment of foodstuffs and may be, for example, a baking chamber.

### BRIEF DESCRIPTION OF THE DRAWINGS

Embodiments of the system are described hereinafter with reference to the accompanying drawings in which:

FIG. 1 shows a schematic side view of an oven with a steam generator according to an embodiment of the system described herein.

FIG. 2 shows a view in section in the plane II-II of the vaporisation chamber of the oven of FIG. 1.

### DETAILED DESCRIPTION OF VARIOUS EMBODIMENTS

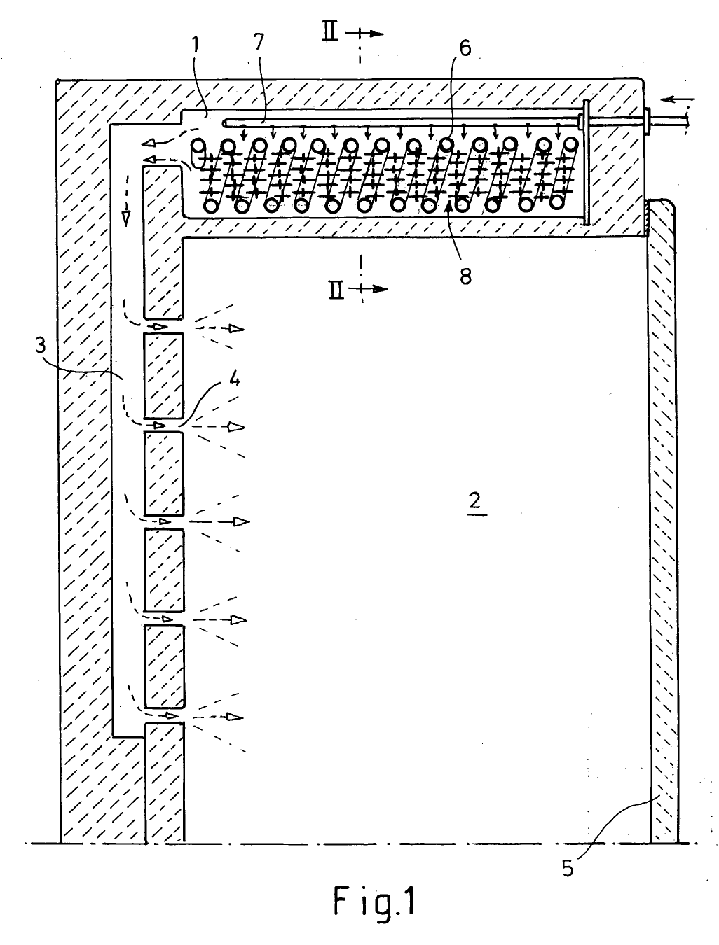

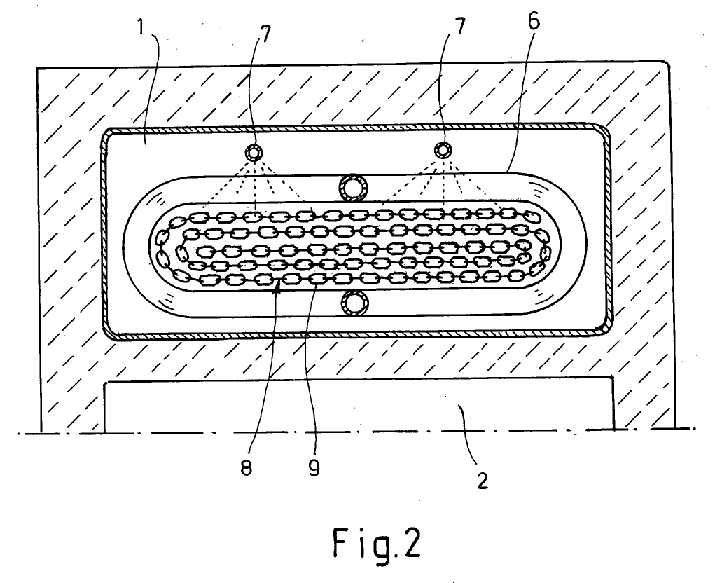

The baking oven shown in FIGS. 1 and 2 includes in the upper region a vaporisation chamber 1 and in the lower region a baking chamber 2 forming the treatment chamber for the foodstuffs to be baked. The means for heating the baking chamber 2 are not shown. The vaporisation chamber 1 is connected to the baking chamber 2 by way of a steam passage 3 which leads to a plurality of openings 4 in the wall of the baking chamber 2, which adjoins the steam passage 3. The baking chamber 2 may be closed by a door 5.

Arranged within the vaporisation chamber 1 is a heating coil 6 which is formed by a hollow metal pipe through which flows a heating medium such as for example a thermal oil or a flue gas. In particular FIG. 2 shows that the heating coil 6 is arranged within the vaporisation chamber 1 in the form of a flat coil.

Disposed above the heating coil 6 are two injection pipes 7 which form the feed device for feeding water into the vaporisation chamber 1. Disposed within the heating coil 6 is a chain 8 which acts as a heat storage body. The chain 8 comprises individual chain links 9 which form the movably interconnected elements of the heat storage body which is in the form of the chain 8. The individual chain links 9 are generally made of steel and are movably connected together.

It is thus possible for the entire volume enclosed by the heating coil 6 to be filled with the movable chain links 9. If necessary the volume enclosed outside the heating coil 6 by the walls of the vaporisation chamber can also be filled with the chain 8.

The injection pipes 7 spray water onto the chain 8 and onto the heating coil 6. If there is no wish for the water to pass directly on to the heating coil 6, the injection pipes 7 can be of such a configuration that they spray water only into the gaps between two pipe portions of the heating coil 6. The water which is sprayed on vaporises by virtue of the transfer of heat from the chain links 9. If the chain links 9 in the upper region are cooled down too greatly to provide for vaporisation of the water, the water can run downwardly on the surface of the chain links 9 under the effect of the force of gravity and encounter hotter chain links which can cause vaporisation of the water.

It is to be noted that the configuration of the heat storage body 8 in the form of a chain affords a number of advantages. The chain 8 may be easily and quickly introduced into the vaporisation chamber 1 and also removed again therefrom. Outside the vaporisation chamber 1, the chain 8 may be more appropriately wound on to a winding drum (not shown). The chain 8 allows the volume of the vaporisation chamber 1 to be completely filled.

The movably interconnected links 9 of the chain 8 form within the vaporisation chamber 1 a labyrinth through which the injected water trickles downwardly, with vaporisation thereof.

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

1. A steam generator, comprising:
a vaporisation chamber in which are disposed at least one heating device, a heat storage body and a water feed device, wherein the heat storage body includes a plurality of small elements that are movably connected together.

2. The steam generator as set forth in claim 1, wherein the vaporisation chamber is connected via at least one steam passage to a treatment chamber for foodstuffs.

3. The steam generator as set forth in claim 2, wherein the treatment chamber is a baking chamber of a baking oven.

4. The steam generator as set forth in claim 1, wherein each of the plurality of small elements of the heat storage body is rigid.

5. The steam generator as set forth in claim 1, wherein the plurality of small elements of the heat storage body are links of a chain, which links project through each other.

6. The steam generator as set forth in claim 1, wherein the plurality of elements of the heat storage body are at least one of: hingedly interconnected ball bodies and sheet metal portions coupled together via connecting rings

7. The steam generator as set forth in claim 1, wherein the elements comprise iron or steel.

8. The steam generator as set forth claim 1, wherein the water feed device includes at least one injection pipe.

9. The steam generator as set forth in claim 1, wherein the heating device includes a heating coil or a heating spiral.

10. The steam generator as set forth in claim 1, wherein the heating device includes a heatable plate.

11. The steam generator as set forth in claim 1, wherein heat energy is fed to the heating device by at least one of the following energy carriers: electric current, hot liquid and hot gas.

12. The steam generator as set forth in claim 11, wherein the hot liquid is heated thermal oil and the hot gas is flue gas produced upon combustion.

13. The steam generator as set forth in claim 1, wherein the plurality of elements of the heat storage body are links of a chain, wherein the water feed device includes at least one injection pipe, and wherein the heating device includes a heating coil or a heating spiral.

14. An apparatus, comprising:
a treatment chamber; and
a steam generator connected to the treatment chamber via at least one steam passage, the steam generator including a vaporisation chamber in which are disposed at least one heating device, a heat storage body and a water feed device, wherein the heat storage body includes a plurality of small elements that are movably connected together.

15. The apparatus as set forth in claim 14, wherein the treatment chamber is adapted for the treatment of foodstuffs.

16. The apparatus as set forth in claim 14, wherein the treatment chamber is a baking chamber.

17. The apparatus as set forth in claim 14, wherein each of the plurality of small elements of the heat storage body is rigid.

18. The apparatus as set forth in claim 14, wherein the plurality of small elements of the heat storage body are chain links.

19. The apparatus as set forth in claim 14, wherein the plurality of elements of the heat storage body are at least one of: hingedly interconnected ball bodies and sheet metal portions coupled together via connecting rings.

20. A steam generator, comprising:
a vaporisation chamber in which are disposed a heating device, a heat storage body and a water feed device, wherein the heat storage body includes a plurality of rigid metal elements that are movably interconnected, and wherein the plurality of rigid metal elements are disposed in a pattern that substantially fills a volume defined by the heating device.
